(19) United States
(12) Patent Application Publication
(10) Pub. No.: US 2018/0371934 A1
(43) Pub. Date: Dec. 27, 2018

(54) SCREW EXPANDER

(71) Applicant: Fu Sheng Industrial Co. Ltd., Taipei City (TW)

(72) Inventor: Yao-Chung Liu, New Taipei City (TW)

(73) Assignee: Fu Sheng Industrial Co. Ltd., Taipei City (TW)

(21) Appl. No.: 15/911,181

(22) Filed: Mar. 5, 2018

(30) Foreign Application Priority Data
Jun. 23, 2017 (TW) 106121001

(51) Int. Cl. F01D 17/14; F01D 17/08; F01D 5/02

(52) U.S. Cl. CPC F01D 17/141; F01D 17/08; F01D 5/023; F05D 2270/3013; F05D 2240/12; F05D 2270/3011; F05D 2240/24

(57) ABSTRACT

A screw expander includes a main body, at least an expansion screw and an adjusting component. The main body has a high pressure region, an expansion region and a low pressure region. The expansion screw is disposed at the expansion region and has an air inlet end and an air outlet end, wherein the air inlet end is connected to the high pressure region, and the air outlet end is connected to the low pressure region. The adjusting component covers the expansion screw, and is adapted to move relatively to the expansion screw to change an opening area of the air inlet end or an opening area of the air outlet end, such that a pressure of an air exhausted from the air outlet end is adjusted.

### CROSS-REFERENCE TO RELATED APPLICATION

This application claims the priority benefit of Taiwan application serial no. 106121001, filed on Jun. 23, 2017. The entirety of the above-mentioned patent application is hereby incorporated by reference herein and made a part of this specification.

### BACKGROUND

### Technical Field

The disclosure relates to an expander, particularly related to a screw expander.

### Description of Related Art

With the development of industrialization, human demand for electricity has increased accordingly. Therefore, many of power generation methods have developed. Among them, the screw expander is driven by an input of high pressure air, and thus generates power.

In general, the greater the differences between the pressure of an air outlet end of the screw expander and the pressure of an exhausted air reaching the low pressure region are, the greater the power consumption is. Therefore, how to effectively control the pressure of the air outlet end of the screw expander to be consistent with the pressure of the low pressure region has become an important issue of designing the screw expander.

### SUMMARY

The invention provides a screw expander, which adjusts the pressure of an air exhausted from an air outlet end of an expansion screw.

The screw expander of the invention includes a main body, at least an expansion screw and an adjusting component. The main body has a high pressure region, an expansion region and a low pressure region. The expansion screw is disposed at the expansion region and has an air inlet end and an air outlet end, wherein the air inlet end is connected to the high pressure region, and the air outlet end is connected to the low pressure region. The adjusting component covers the expansion screw, and is adapted to move relatively to the expansion screw to change an opening area of the air inlet end or an opening area of the air outlet end, such that a pressure of an air exhausted from the air outlet end is adjusted.

In an embodiment of the invention, an end of the adjusting component has a recess. When the adjusting component moves to a first position, the recess is aligned with the air inlet end to increase an opening area of the air inlet end. When the adjusting component moves to a second position, the recess is dislocated with the air inlet end to reduce the opening area of the air inlet end.

In an embodiment of the invention, the end of the adjusting component has the recess. When the adjusting component moves to the first position, the recess is aligned with the air outlet end to increase the opening area of the air outlet end. When the adjusting component moves to the second position, the recess is dislocated with the air outlet end to reduce the opening area of the air outlet end.

In an embodiment of the invention, the adjusting component is adapted to move back and forth along a move direction. The move direction is parallel to a rotation axis of the expansion screw.

In an embodiment of the invention, the adjusting component has a guide slot. The main body has a guide convex, and the adjusting component is slidably disposed on the guide convex by the guide slot.

In an embodiment of the invention, the screw expander includes a control module. The control module is adapted to sense the pressure of an expansion region and the pressure of a low pressure region, and thus controls movements of the adjusting component.

In an embodiment of the invention, the main body or the adjusting component has a via. The via is connected to the expansion region. The control module senses the pressure of the expansion region through the via.

In an embodiment of the invention, the expansion screw has a plurality of screw thread segments. A first screw thread of the screw thread segments is adjacent to the air outlet end. A second screw thread of the screw thread segments is adjacent to the first screw thread but is not adjacent to the air outlet end. The via is connected to the second screw thread.

In an embodiment of the invention, a distance of the via and the air outlet end is shorter than a distance of the via and the air inlet end.

In an embodiment of the invention, a length of the adjusting component is greater than a length of the expansion screw.

Based on the above, in the screw expander of the invention, the adjusting component moves relatively to the expansion screw to change the coverage rate of the adjusting component covering the air inlet end of the expansion screw or the coverage rate of the adjusting component covering the air outlet end of the expansion screw. Thus, the opening area of the air inlet end or the opening area of the air outlet end is changed. By changing the opening area of the air inlet end or changing the opening area of the air outlet end, the pressure of the air exhausted from the air outlet end is adjusted, such that the pressure of the air exhausted from the air outlet end is equal to the pressure of the low pressure region. The power consumption of the screw expander is thus reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of some of components of a screw expander according to an embodiment of the invention.

FIG. 1B is another cross-section of a schematic view of some of components of a screw expander of FIG. 1A.

FIG. 2 illustrates the movement of an adjusting component of FIG. 1A.

FIG. 3 is a block diagram of some of components of the screw expander of FIG. 1A.

FIG. 4 is a schematic partial view of a main body and an adjusting component of FIG. 1A.

FIG. 5 is a schematic view of some of components of a screw expander according to another embodiment of the invention.

FIG. 6 illustrates the movement of an adjusting component of FIG. 5.

### DESCRIPTION OF THE EMBODIMENTS

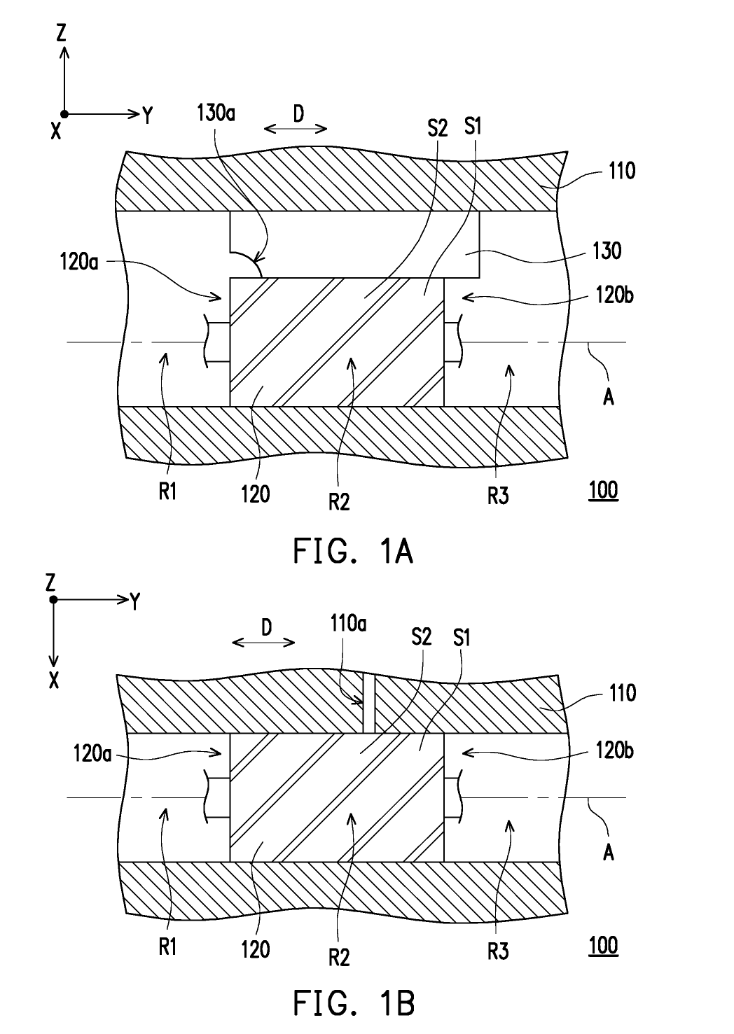

FIG. 1A is a schematic view of some of components of a screw expander according to an embodiment of the invention. Please refer to FIG. 1A. A screw expander 100 of the embodiment includes a main body 110 and at least an expansion screw 120. The main body 110 has a high pressure region R1, an expansion region R2, and a low pressure region R3. The expansion screw 120 is disposed at the expansion region R2 and has an air inlet end 120a and an air outlet end 120b. The air inlet end 120a is connected to the high pressure region R1. The air outlet end 120b is connected to the low pressure region R3. The high pressure air inputted from the air inlet end 120a drives the expansion screw 120 to rotate, such that the expansion screw 120 proceeds work, such as power generation. FIG. 1A simply illustrates the single expansion screw 120. However, the invention is not limited thereto. It can also be in the shape of twin expansion screw.

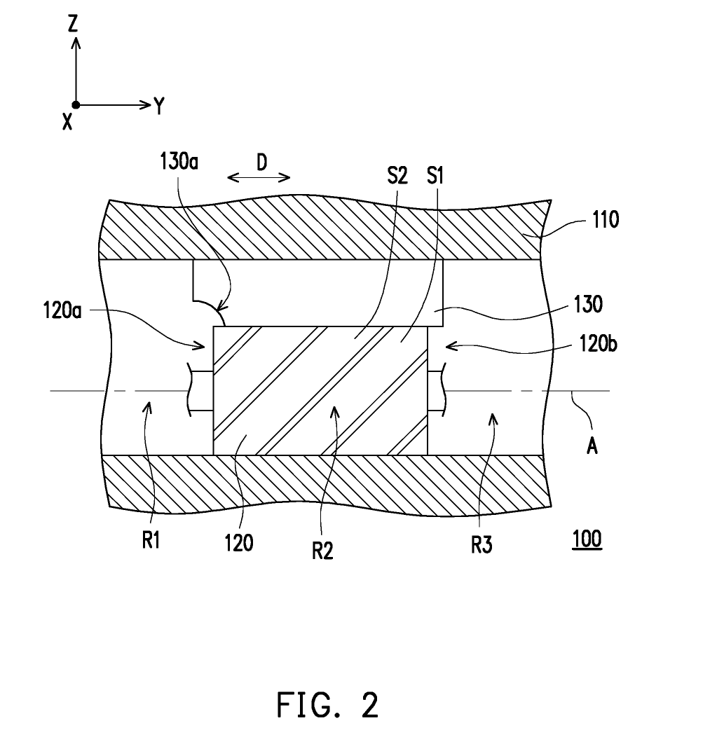

FIG. 2 illustrates the movement of an adjusting component of FIG. 1A. The screw expander 100 of the embodiment further includes an adjusting component 130. The adjusting component 130 covers at least part of the outside of the expansion screw 120, and is adapted to move relatively to the expansion screw 120 along the move direction D between the state illustrated as FIG. 1A and the state illustrated as FIG. 2, and the opening area of the air inlet end 120a is changed to adjust the pressure of the air exhausted from the air outlet end 120b of the expansion screw 120, such that the air exhausted from the air outlet end 120b of the expansion screw 120 is equal to the pressure of the low pressure region R3. The power consumption of the screw expander 100 is thus reduced. In the embodiment, the move direction D of the adjusting component 130 is, for example, parallel to a rotation axis A of the expansion screw 120.

Specifically, the end of the adjusting component 130 which is closer to a high pressure region R1 has a recess 130a. When the adjusting component 130 moves to a first position illustrated as FIG. 1A, the recess 130a is aligned with the air inlet end 120a to increase the opening area of air inlet end 120a. At this time, the air pressure entering the expansion screw 120 drops, such that the air pressure exhausted from the air outlet end 120b drops accordingly. In contrast, when the adjusting component 130 moves to the second position illustrated as FIG. 2, the recess 130a is dislocated with the air inlet end 120a to reduce the opening area of the inlet end 120a. At this time, the air pressure entering the expansion screw 120 pressure rises, such that the air pressure exhausted from the air outlet end 120b rises accordingly.

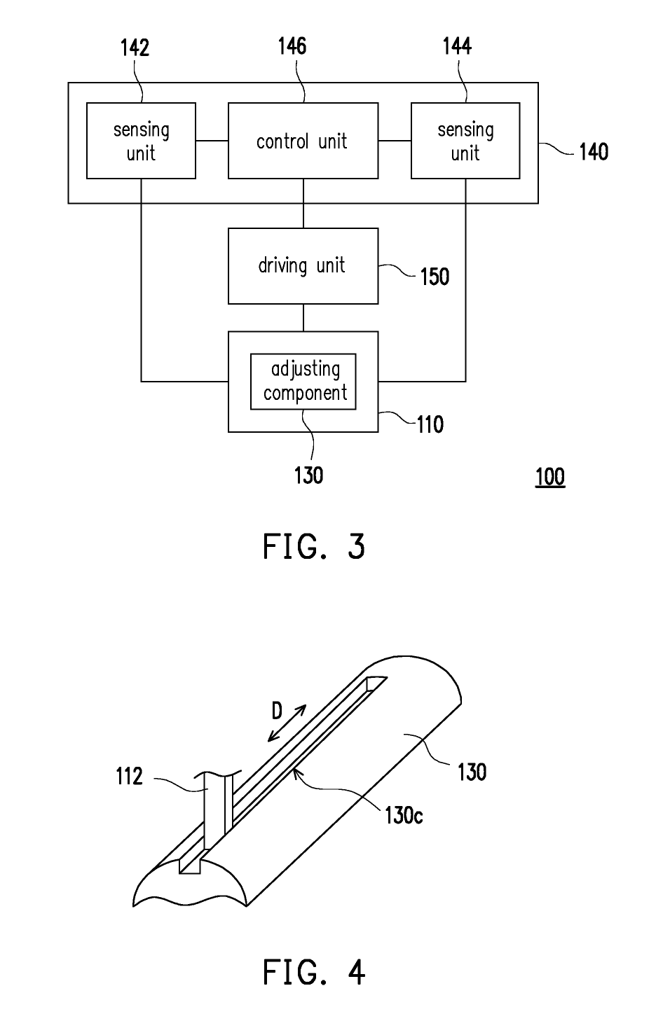

FIG. 3 is a block diagram of some of components of the screw expander of FIG. 1A. Please refer to FIG. 1 A and FIG. 3. The screw expander 100 of the embodiment further includes a control module 140. The control module 140 is adapted to sense the pressure of the expansion region R2 of the main body 110 and the pressure of the low pressure region R3 of the main body 110 respectively by a sensing unit 142 and a sensing unit 144. The control unit 146 controls the movements of the adjusting component 130 by the driving unit 150 according to the sensing signal from the sensing unit 142 and the sensing unit 144, and makes the air pressure exhausted from the air exhausted from the air outlet end 120b of the expansion screw 120 is equal to the pressure of the low pressure region R3. The sensing unit 142 and the sensing unit 144 are, for example, suitable kinds of pressure sensing components. The driving unit 150 is, for example, a suitable kind of actuator. However, the invention is not limited thereto.

FIG. 1B is another cross-section of a schematic view of some of components of a screw expander of FIG. 1A. In detail, in the embodiment, the main body 110 illustrated as FIG. 1B has a via 110a. The via 110a is connected to the expansion region R2. The sensing unit 142 of the control module 140 senses the pressure of the expansion region R2 through the via 110a. That is, when the recess 130a is at the air inlet end 120a, the via 110a is disposed at the main body 110. Furthermore, the expansion screw 120 has a plurality of screw thread segments. A first screw thread S1 of the screw thread segments is adjacent to the air outlet end 120b. A second screw thread S2 is adjacent to the first screw thread S1, but is not adjacent to the air outlet end 120b. The via 110a of the main body 110 is connected to the second screw thread S2 to positively sense the air pressure of the expansion region R2, which is not yet, but is about to reach the air outlet end 120b. Under this configuration, the distance of the via 110a of the main body 110 and the air outlet end 120b of the expansion screw 120 moving along the move direction D is, for example, shorter than the distance of the via 110a of the main body 110 and the air inlet end 120a of the expansion screw 120 moving along the move direction D. However, the invention is not limited thereto. In addition, the length of the adjusting component 130 of the embodiment moving along the move direction D is greater than, for example, the distance of the expansion screw 120 moving along the move direction D to effectively covers the expansion screw 120. However, the invention is not limited thereto. It should be noted that, to make the drawings clear, FIG. 1A and FIG. 1B are illustrated in cross-section manners of parts of the main body 110. In fact, the main body 110 and the adjusting component 130 both cover the expansion screw 120. The expansion screw 120 is only exposed at part of the areas of the air inlet end 120a and the air outlet end 120b to provide air inlet and air outlet.

FIG. 4 is a schematic partial view of a main body and an adjusting component of FIG. 1A. Please refer to FIG. 4. The adjusting component 130 of the embodiment has a guide slot 130c. The main body 110 (illustrated as FIG. 1A) has a guide convex 112. The adjusting component 130 is slidably disposed on a guide convex 112 along the move direction D by the guide slot 130c, such that the adjusting component 130 smoothly moves along the move direction D. In other embodiments, the adjusting component 130 slidably disposed on the guide convex 112 could be carried out by other suitable structures. However, the invention is not limited thereto.

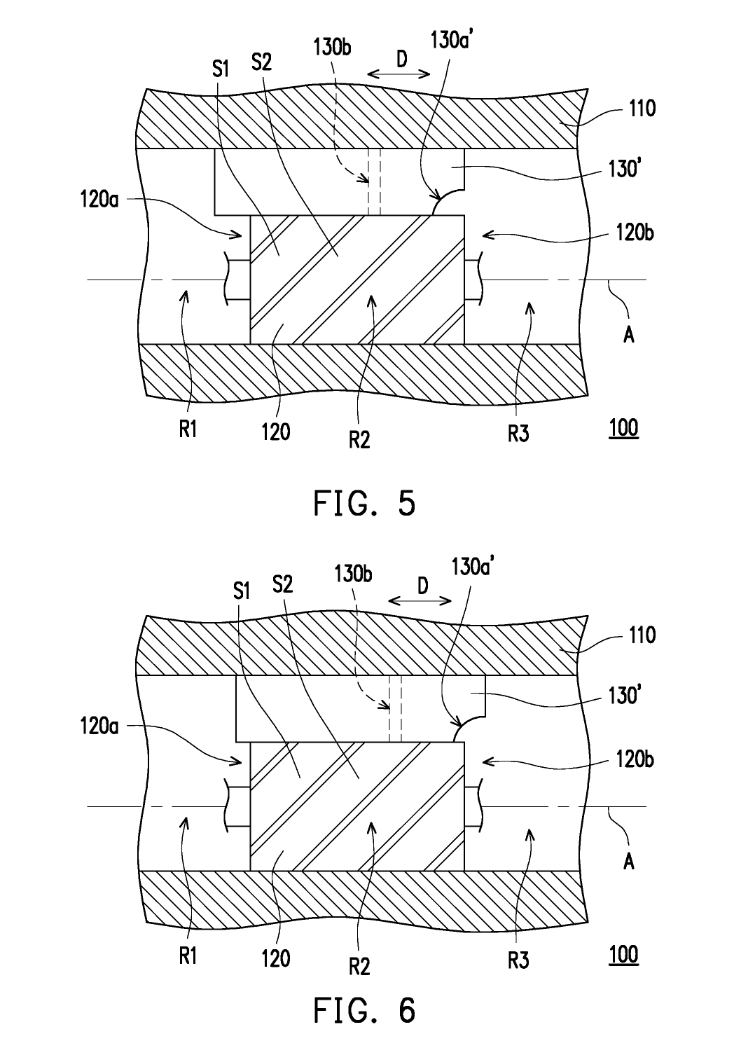

FIG. 5 is a schematic view of some of components of a screw expander according to another embodiment of the invention. FIG. 6 illustrates the movement of an adjusting component of FIG. 5. The difference between the embodiments illustrated as FIG. 5 and FIG. 6 and the embodiments illustrated as FIG. 1A, FIG. 1B, and FIG. 2 is that a recess 130a′ of an adjusting component 130′ is located at the end adjacent the low pressure region R3 of the adjusting component 130. When the adjusting component 130′ moves to the first position illustrated as FIG. 3, the recess 130a′ is aligned with the air outlet end 120a to increase the opening area of the air outlet end 120a, such that the air pressure exhausted from the air outlet end 120b drops. In contrast, when the adjusting component 130 moves to the second position illustrated as FIG. 4, the recess 130a′ is dislocated with the air outlet end 120a to reduce the opening area of the air outlet end 120a, such that pressure of the air exhausted from the air outlet end 120b rises. Besides, in the embodiments illustrated as FIG. 5 and FIG. 6, the via 130b is formed on the adjusting component 130′, and is not consistent with the embodiment illustrated as FIG. 1B that the via 110a is formed on the main body 110. That is, when the recess 130a′ is at air outlet end 120b, the via 130b is disposed at the adjusting component 130′. The descriptions of the rest of the configuration and effects of the via 130b are similar to those of the via 110a illustrated as FIG. 1B and will not be repeated for this embodiment.

In summary, in the screw expander of the invention, the adjusting component moves relatively to the expansion screw and change the coverage rate of the adjusting component covering the air inlet end or the coverage rate of the adjusting component covering the air outlet end of the expansion screw, and the opening area of the air inlet end or the opening area of the air outlet end is thus changed. With changes of the opening area of the air inlet end or changes of the opening area of the air outlet end, the pressure of an air exhausted from the air outlet end is adjusted. The pressure of the air exhausted from the air outlet end of expansion screw is equal to the distance of the low pressure region. The power consumption of the screw expander is thus reduced.

Although the embodiments are already disclosed as above, these embodiments should not be construed as limitations on the scope of the invention. It will be apparent to those ordinarily skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. A screw expander comprising:
a main body, having a high pressure region, an expansion region, and a low pressure region;
at least an expansion screw, disposed at the expansion region and having an air inlet end and an air outlet end, wherein the air inlet end is connected to the high pressure region, and the air outlet end is connected to the low pressure region; and
an adjusting component, covering the expansion screw, and adapted to move relatively to the expansion screw to change an opening area of the air inlet end or an opening area of the air outlet end, such that a pressure of an air exhausted from the air outlet end is adjusted.

2. The screw expander according to claim 1, wherein an end of the adjusting component has a recess; when the adjusting component moves to a first position, the recess is aligned with the air inlet end to increase an opening area of the air inlet end; when the adjusting component moves to a second position, the recess is dislocated with the air inlet end to reduce the opening area of the air inlet end.

3. The screw expander according to claim 1, wherein the end of the adjusting component has the recess; when the adjusting component moves to the first position, the recess is aligned with the air outlet end to increase the opening area of the air outlet end; when the adjusting component moves to the second position, the recess is dislocated with the air outlet end to reduce the opening area of the air outlet end.

4. The screw expander according to claim 1, wherein the adjusting component is adapted to move back and forth along a move direction, and the move direction is parallel to a rotation axis of the expansion screw.

5. The screw expander according to claim 1, wherein the adjusting component has a guide slot, the main body has a guide convex, and the adjusting component is slidably disposed on the guide convex by the guide slot.

6. The screw expander according to claim 1, comprising a control module, wherein the control module is adapted to sense pressure of an expansion region and pressure of a low pressure region, and thus controls movements of the adjusting component.

7. The screw expander according to claim 6, wherein a main body or the adjusting component has a via, the via is connected to the expansion region, and the control module senses the pressure of the expansion region through the via.

8. The screw expander according to claim 7, wherein the expansion screw has a plurality of screw thread segments, a first screw thread of the screw thread segments is adjacent to the air outlet end, a second screw thread of the screw thread segments is adjacent to the first screw thread but is not adjacent to the air outlet end, and the via is connected to the second screw thread.

9. The screw expander according to claim 7, wherein a distance of the via and the air outlet end is shorter than a distance of the via and the air inlet end.

10. The screw expander according to claim 1, wherein a length of the adjusting component is greater than a length of the expansion screw.
